(19) United States
(12) Patent Application Publication
(10) Pub. No.: US 2008/0120598 A1
(43) Pub. Date: May 22, 2008

(54) Method and apparatus of a build management system

(75) Inventor: Vyacheslav Imeshev, Palo Alto, CA (US)

Correspondence Address: Raj Abhyanker, LLP;c/o Intellevate, P.O. Box 52050, Minneapolis, MN, 55402, US

(73) Assignee: VIEWTIER SYSTEMS, INC.

(21) Appl. No.: 11/602,679

(22) Filed: Nov. 20, 2006

(51) Int. Cl. G06F 17/30; G06F 9/44

(52) U.S. Cl. 717/120; 717/124; 717/104; 717/115; 707/6; 717/109

(57) ABSTRACT

A method and apparatus of a build management system is disclosed. In one embodiment, a system includes a code of a software product, site to develop, to test, and to perform quality assurance of the code of the software product and a software build management server, having a number of build modules to build the code, to identify a breakage point of the code, and to provide a previous clean state of the code. In addition, the system may include a version control system to provide a change list to track a number of changes to the code and to provide a feedback of the number of changes. The system may also include a remote build module of the at least one site to build the code of the software product and/or to synchronize with the software build management server and the version control system.

### FIELD OF TECHNOLOGY

This disclosure relates generally to the technical fields of software development and, in one example embodiment, method, and apparatus and system of a build management.

### BACKGROUND

Developing a software application (e.g., a computer program, a system administration application, a web application, a network application, a GUI application, etc.) may require collaboration, management, organization, and/or teamwork of various users (e.g., programmers, project managers, officers, software and/or hardware engineers, scientists, testers, human-computer interaction specialists) of various sites (e.g., offices, headquarters, institutes, universities, homes, off-shore sites, and/or remote build sites) of different geographic locations. The various users may work (e.g., modify, test, execute, etc.) from a code base (e.g. a working space (e.g., a database of source code (e.g., header files, definition files, implementation files, interpreted files) and/or object code (e.g., binary files, object files, executable files, syntax trees, modules, libraries, application programming interfaces (API)) of a version control system (e.g., to track, manage, and/or provide information of multiple versions, revisions, and/or submissions of files of the code base (e.g., a time stamp, a counter, etc.)).

The version control system may be coupled to a build management server (e.g., an application to compile, run, link, and/or interpret a set of instructions of any of a number of files of the code base). The build management server may perform a build (e.g., a schedule build, a manual build, an integration build) of any of the files of the code base in order to develop the software application for release (e.g., a software product release). The build may include a build configuration (e.g., a set of items that define the build). The set of items may include a build name, a location information (e.g., a port, an IP address, a path) of a file of the version control system, a schedule to poll version control system for changes to the code base, a log, a build result location and/or publication, access privileges, and/or a publication selection. The various users may select any combination of the files of the code base for the build. The manual build may be a build initiated by an authorized user. The schedule build may be a build performed according to a timetable (e.g., daily, weekly, hourly, and/or a definable, dynamic timetable). The integration build may be a build performed upon a check-in by a user (e.g., when a user submits changes to the code base).

A timeline of development of the files of the code base by the various users (e.g., a code line) may indicate a number of different states of the code base of the build (e.g., clean, broken, etc.). A head of the code line may be a state of the code base when a last check-in was preformed (e.g., a latest modification of the code base). A clean state may be able to compile and/or execute without error. A criteria of the clean state may be defined by an architect and/or a manager of the software application. A broken state may include errors (e.g., run-time errors, packaging errors, linking errors, compilations errors, and/or interpretation errors). Similarly, code in the broken state may not be compiled, executed, and/or interpreted by the build management server. The broken state may result from a submission to the code base that causes the build to break (e.g., a code change of a particular user that results in a compilation error, segmentation fault, run time error, core dump, and/or any other error related to the development of the software application).

The code base in the broken state may disrupt (e.g., prevent) development and/or distribution of the software application, whereas the clean state may enable release of the software application to the market. In addition, if the head of the code line is not transformable to the clean state (e.g., broken state), then the various users may not be able to perform their operation on the code base (e.g., the various users may not be able test, run quality assurance, and/or develop the software application if the code base cannot compile and/or execute) and/or the software application release may be postponed. Moreover, the particular user responsible for the broken state (e.g., caused the broken state and/or responsible for maintaining the clean state of the code base) may not be available (e.g., on vacation, out for the weekend, out fishing, etc). Consequently, the various users may not be able to work from the code base until someone returns and/or fixes the errors of the code base.

Furthermore, the code base may include hundreds of files and/or modules where each file may include thousands of lines of instructions. Management of the code base may be a difficult, time-consuming task. An individual responsible for management of the code base may find it confusing and difficult to track which versions of the files of the code base were built by the build management server.

In conclusion, valuable working time may be lost, salaries of unproductive employees may still need to be paid, software releases may be postponed, and production delays may occur as a result of poor build management.

### SUMMARY

A method and apparatus of a build management system is disclosed. In one aspect, a system includes a code of a software product (e.g., a document application, a organizer application, a web application), at least one site to develop, to test, and to perform quality assurance of the code of the software product and a software build management server having a number of build modules to build the code, to identify a breakage point of the code, and to process and to provide a previous clean state of the code.

The system may also include a version control system to provide a change list to track a number of changes to the code and to provide a feedback of the number of changes. In addition, the system may also include remote build module of the site to build the code of the software product and/or to synchronize with the software build management server and the version control system.

The system may further include a publication module of at least one site to publish a set of results of a build and to define a set of access privileges of the set of results. Furthermore, the software build management server may define a build configuration as a set of parameters of the build of the code and/or may archive the build configuration to enable reproduction of the build.

In another aspect, a method includes providing a code of a software product and/or a previous clean state of the code, modifying the code by various users of a number of sites, building the code to integrate modifications of the code with the previous clean state of the code and/or updating the previous clean state of the code upon a successful build and/or identifying a breakage point of the code such that the code cannot build successfully caused by any one of the modification.

The method also may include building the previous clean state of the code upon identification of the breakage point to enable development of the software product and/or to mitigate problems associated with an unsuccessful build of the code. In addition, the method may include publishing a set of results of a build of the code to a page accessible by various users of any of the number of sites. Moreover, the method may include defining a set of access privileges to the page of the various users. The method may include defining and archiving a build configuration of the build and/or reproducing the build based on a set of parameters of the build configuration. The method may also include defining a build group of build to organize the build.

In yet another aspect, an apparatus includes a data processing system to manage development of a software product, a database coupled to the data processing system to provide a code of the software product and to archive a build configuration of a build, and a build module of the data processing system to parse and/or to translate the code to create an executable state of the code, to identify a breakage point of the code, and to provide a previous clean state of the code. The apparatus may further include a schedule build module of the data processing system to parse and/or to translate the code to create the executable state of the code according to a definable timetable and to process the previous clean state of the code to enable testing, development, and distribution of the software product.

The apparatus may also include an integration build module of the data processing system to integrate a code change of the code with the previous clean state of the code and/or to provide the schedule build module with a clean state of the code. In addition, the apparatus may include a remote build module coupled to the data processing system to parse and/or to translate the code to create the executable state of the code from a remote site, and/or to provide the executable state of the code to the data processing system. Also, the apparatus may include a publication module coupled to the data processing system to publish a set of results of the build of the code to enable access of the set of results by various users, and/or to define a set of access privileges of the set of results. The apparatus may include a historical build module of the data processing system to reproduce the build based on information of the build configuration.

Furthermore, the apparatus may include a version control system coupled to the data processing system to process a submission to the code, to keep track of code changes, to provide a change list of the code changes and/or to provide a feedback of the code changes. The apparatus may include a regular expression generator module of the data processing system to generate a regular expression of a definable string to search a log of the build. In addition, the apparatus may include a discovery module of the data processing system to establish a presence of at least one software configuration management component.

The apparatus may also include an administration module of the data processing system to define a build group having at least one build. Moreover, the apparatus may include an interface module of the data processing system to display at least one of the log, the set of results, and a status of the build group. Moreover, the apparatus may include a load balancing module of the data processing system to optimize performance of any of the at least one software configuration management component and the build module.

The methods, systems, and apparatuses disclosed herein may be implemented in any means for achieving various aspects, and may be executed in a form of a machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

Example embodiments are illustrated by way of example and not limitation in the figures of the accompanying drawings, in which like references indicate similar elements and in which:

FIG. 1 is a system view of a software build management server communicating through a network with a version control system, a code database and site(s), according to one embodiment.

FIG. 2 is a code line view of a schedule build using previous clean build, according to one embodiment.

FIG. 3 is an interface view of the result view, according to one embodiment.

FIG. 4A is an interface view of build run parameters, according to one embodiment.

FIG. 4B is an interface view of the build run parameters, according to one embodiment.

FIG. 5 is an interface view of user interface, according to one embodiment.

FIG. 6 is a diagrammatic system view of a data processing system in which any of the embodiments disclosed herein may be performed, according to one embodiment.

FIG. 7A is a display group view of a build display, according to one embodiment.

FIG. 7B is a display group view of a select display group, according to one embodiment.

FIG. 8 is a table view of a build configuration table, according to one embodiment.

FIG. 9A is a histogram view of a breakage build histogram, according to one embodiment.

FIG. 9B is a histogram view of a breakage build histogram, according to one embodiment

FIG. 10A is a process flow of providing a code of a software product, according to one embodiment.

FIG. 10B is a continuation of process flow of FIG. 10A showing additional processes, according to one embodiment.

Other features of the present embodiments will be apparent from the accompanying drawings and from the detailed description that follows.

### DETAILED DESCRIPTION

A method and apparatus of a build management system is disclosed. In the following description, for the purposes of explanation, numerous specific details are set forth in order to provide a thorough understanding of the various embodiments. It will be evident, however to one skilled in the art that the various embodiments may be practiced without these specific details.

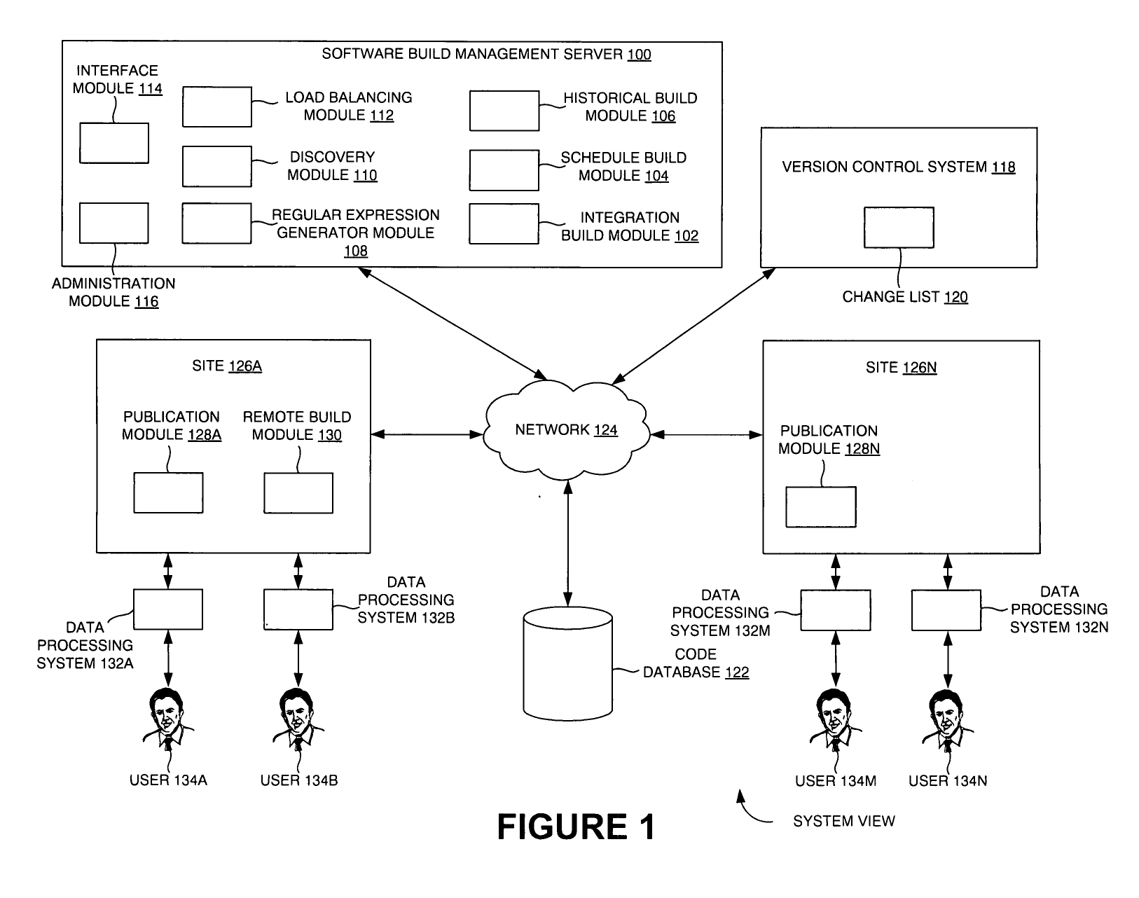

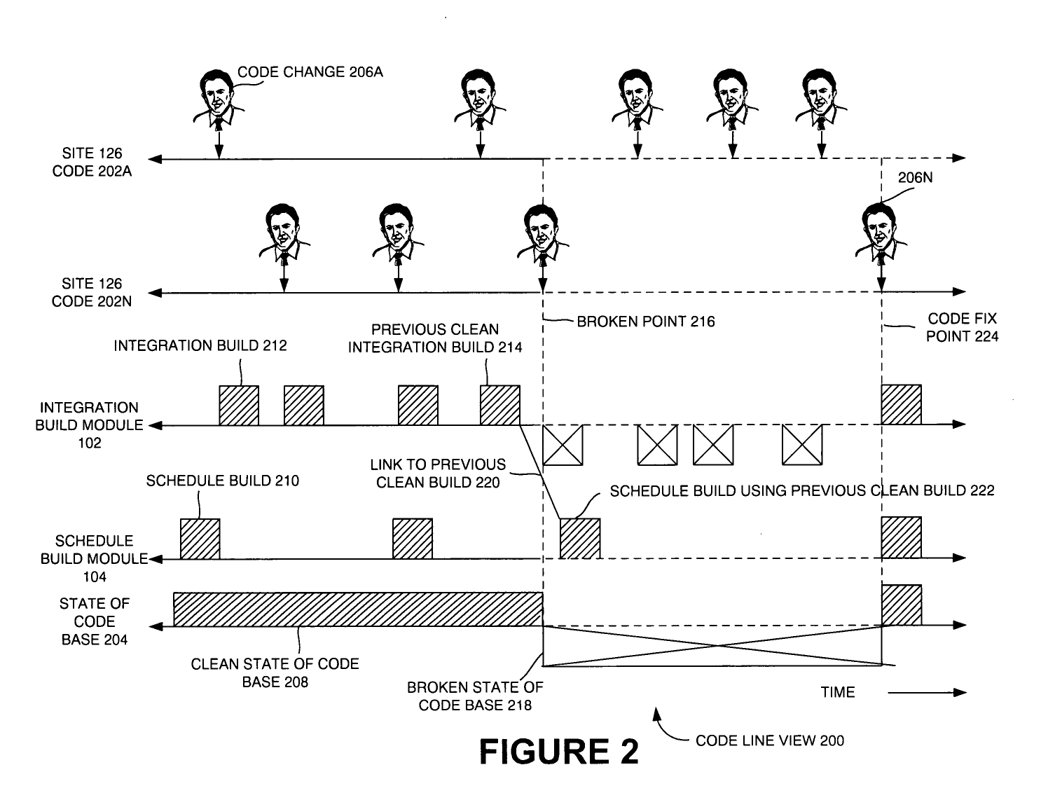

In one embodiment, a system includes a code (e.g., a code 202 A-N of FIG. 1) of a software product, a site (e.g., a site 126A-N of FIGS. 1-2) to develop, to test, and/or to perform quality assurance of the code (e.g., performed by a user 134 A-N of FIGS. 1-2) of the software product, and a software build management server (e.g., a software build management server 100 of FIG. 1), having a number of build modules (e.g., an integration build module 102, a schedule build module 104, a historical build module 106, a regular expression generator module 108, etc. of FIGS. 1-2) to build the code (e.g., the code 202 A-N of FIG. 1), to identify a breakage point of the code (e.g., the broken point 216 of FIG. 2), and to process (e.g., a schedule build using previous clean build 222) and to provide a previous clean state of the code (e.g., previous clean integration build 214 of FIG. 2).

In another embodiment, a method includes providing a code (e.g., the code 202 A-N of FIG. 1) of a software product and a previous clean state of the code (e.g., previous clean integration build 214 of FIG. 2), modifying the code by various users (e.g., the user 134 A-N of FIGS. 1-2) of a number of sites (e.g., the site 126A-N of FIGS. 1-2), building the code to integrate modifications of the code with the previous clean state of the code (e.g., through integration build module 102 of FIGS. 1-2) and updating the previous clean state of the code upon a successful build, and identifying a breakage point of the code (e.g., the broken point 216 of FIG. 2) such that the code cannot build successfully caused by any one of the modification.

In yet another embodiment, an apparatus includes a data processing system (e.g., the data processing system 132 A-N of FIG. 1) to manage development of a software product, a database (e.g., the code database 122 of FIG. 1) coupled to the data processing system to provide a code (e.g., the code 202 A-N of FIG. 1) of the software product and to archive a build configuration of a build, and a build module (e.g., the integration build module 102, the remote build module 130, etc. of FIG. 1) to parse and to translate the code to create an executable state of the code, to identify a breakage point of the code (e.g., the broken point 216 of FIG. 2), and to provide a previous clean state of the code (e.g., the previous clean integration build 214).

FIG. 1 is a system view of a software build management server 100 communicating through a network 124 with a version control system 118, a code database 122 and site 126 A-N, according to one embodiment. Particularly the FIG. 1 illustrates the software build management server 100, the integration build module 102, the schedule build module 104, the historical build module 106, the regular expression generator module 108, a discovery module 110, a load balancing module 112, an interface module 114, and an administration module 116. The version control system 118, a code database 122, the network 124, the site 126 A-N, a data processing system 132 A-N, a user 134 A-N, according to one embodiment. For example, the software build management server 100 may be a data processing system to manage and/or to facilitate development and/or distribution of a software product. The software build management server 100 may include a number of build modules (e.g., the integration build module 102, the schedule build module 104, etc. of FIG. 1) that may perform a build (e.g., compile, execute, run, link, package, and/or interpret a set of instructions) of the any files of the code database 122 in order to develop the software application. The software build management server 100 may also identify a breakage point of the code and/or may also process (e.g., a schedule build using previous clean build 222 of FIG. 2) and/or provide previous clean state of the code (e.g., previous clean integration build 214 of FIG. 2).

The integration build module 102 may perform the integration of the code (e.g., the code database 122 of FIG. 2) from the code database 122 when ever the build is requested by the user 134 A-N who may be located at different site 126 A-N. The schedule build module 104 may perform the schedule build (e.g., the schedule build 210 of FIG. 2) at a definable timetable.

The historical build module 106 of the software build management server 100 may contain the information of the build configuration and/or may reproduce the build when requested by the user 134 A-N. The regular expression generator module 108 may provide a regular expression of a definable string to search a log of the build requested by the user 134 A-N. The discovery module 110 may be associated with locating the presence of components (e.g., issue/bug tracking systems, version control systems, and/or project and requirements management systems) of software configuration management (e.g., includes configuration identification, configuration control status accounting, review build management, process management, environment management, teamwork, and/or defect tracking). The load balancing module 112 may perform the role of balancing of a workload (e.g., a set of tasks, operations, and/or duties to be performed) of various nodes of the system (e.g., the remote build module 130, the data processing system 132A-N, the code database 122, the version control system 118, etc.) of the system and/or may be associated with optimizing the performance of the components of the software build management server 100 and the other build modules (e.g., the integration build module, the schedule build module, etc.). The interface module 114 may be associated with displaying the information related to the build and/or may perform the functions (e.g., switching from simple and detailed views of information(e.g., results) of the build) as requested by the user 134A-N. The administration module 116 may help in administering management of the site 126A-N, and/or may be associated with defining the build group that may contain at least one build.

The version control system 118 may track the all the revisions (e.g., stored in the code database 122) performed by the any of the user 134A-N of the data processing system 132A-N during development of the software product. The change list 120 may also provide the list of the modifications to the set of instructions of the files of the code database 122 performed by the user 134A-N. The code database 122 may contain all the files of the software application and/or may provide the necessary files (e.g., header files, definition files, compilation files, etc.) for access by user 134A-N during the build run. The network 124 may be a personal area network, a local area network, a wireless local area network, a wide area network, a storage area network, and/or a process control network that may enable efficient two way communication between various major components of the system namely the software build management server 100, the version control system 118, the code database 122, site 126A-N, etc. The site 126A-N may be physical locations (e.g., facilities, offices, buildings, headquarters, etc.) from where the user 134A-N may perform the build of the software product through a network 124. The site 126A-N may include the publication module 128 A-N and/or remote build module 130. The publication module 128 A-N may publish information of the build implemented by the user 134A-N from the site 126A-N. The remote build module 130 may facilitate the user 134A-N to build, test etc. The code of the software product at remote site. The data processing system 132A-N may be computers, supercomputers, and/or calculators, which may facilitate the interaction between user 134A-N and site 126A-N to enable processing (e.g., testing, modifying, executing, etc.) of the code of the software product. The user 134A-N may be the programmers, testers, project managers, engineers, etc who may work from the remote site.

In example embodiment illustrated in FIG. 1, the software build management server 100 may communicate through the network 124 with the version control system 118, the code database 122, the site 126A-N. The user 134A-N may communicate with the site 126A-N through the data processing system 132A-N, as illustrated in example embodiment of FIG. 1.

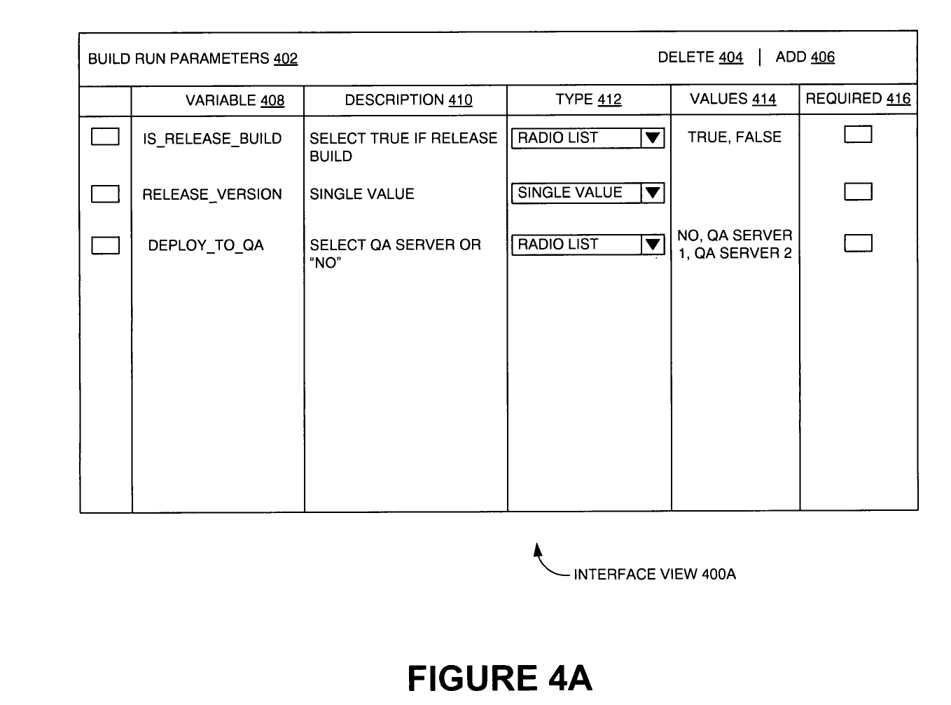

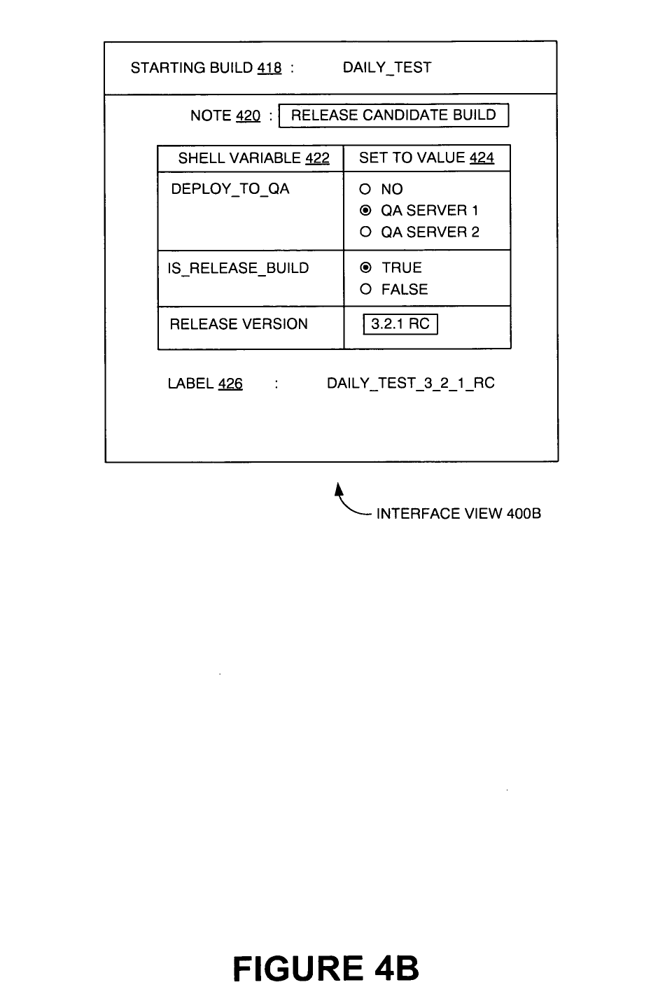

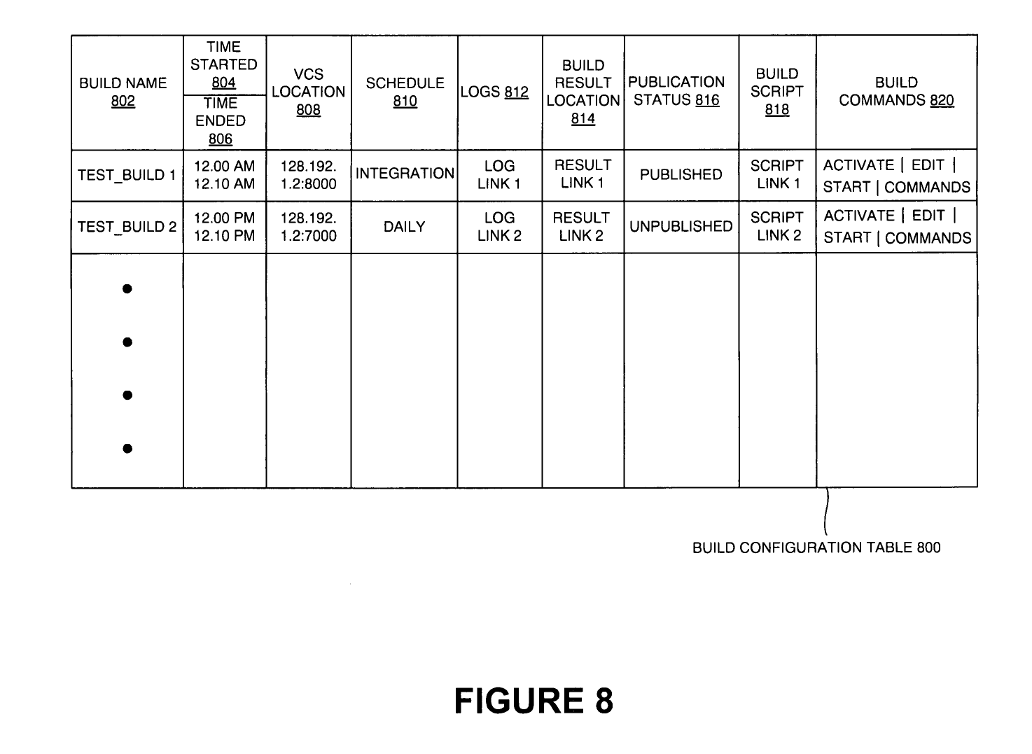

For example, a system includes a code (e.g., the code 202A-N of FIG. 2) of a software product, a site (e.g., the site 126A-N of FIGS. 1-2) to develop, to test, and to perform quality assurance of the code (e.g., performed by the user 134A-N using the data processing system 132A-N of FIG. 1) of the software product and/or a software build management server (e.g., the software build management server (e.g., the software-build management server 100 of FIG. 1) may define a build configuration as a set of parameters of the build of the code (e.g., through the build run parameters 402 of FIG. 4A) and/or may archive the build configuration (e.g., the build configuration table 800 of FIG. 8) to enable reproduction of the build, having a number of build modules (e.g., an integration build module 102, a schedule build module 104, etc. of FIGS. 1-2) to build the code (e.g., the code 202A-N of FIG. 2b), to identify a breakage point of the code (e.g., the broken point 216 of FIG. 2), and to process and to provide a previous clean state of the code (e.g., previous clean integration build 214 of FIG. 2). In addition, the system may include a version control system (e.g., the version control system 118 of FIG. 1) that may provide a change list (e.g., the change list 120 of FIG. 1) to track a number of changes to the code (e.g., the code 202A-N of FIG. 1) and/or may provide a feedback of the number of changes.

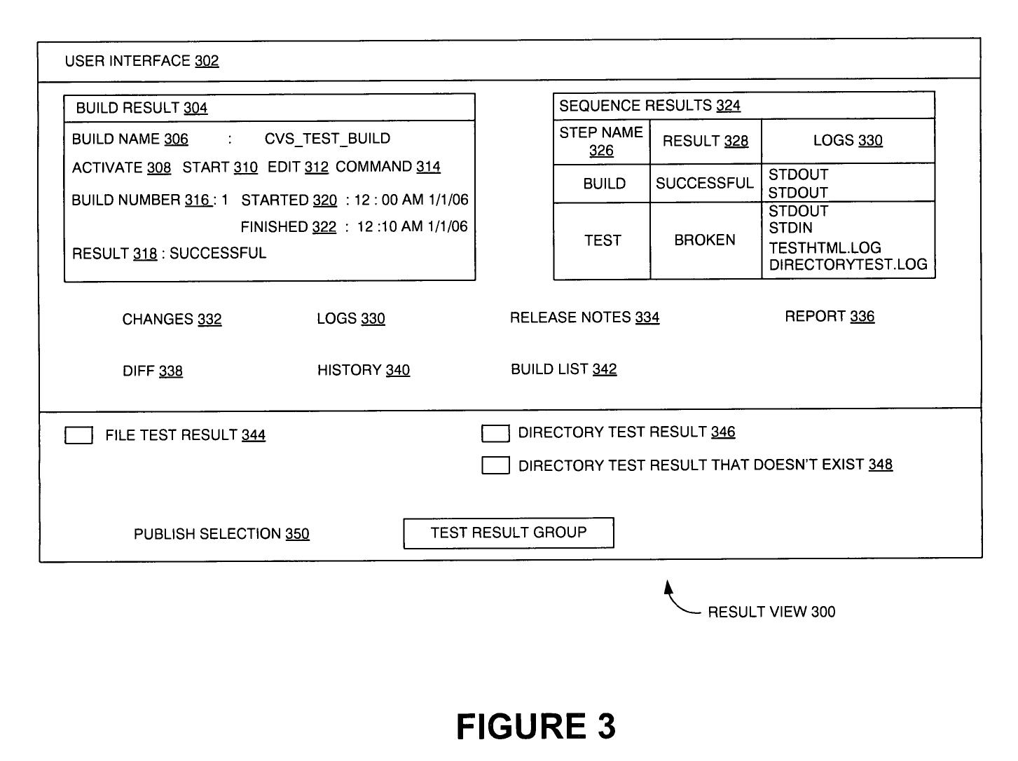

The system may also include a remote build module (e.g., the remote build module 130 of FIG. 1) of the site (e.g., the site 126A-N of FIGS. 1-2) to build the code (e.g., the code 202A-N of FIG. 2) of the software product and/or to synchronize with the software build management server (e.g., the software build management server 100 of FIG. 1) and the version control system (e.g., the version control system 118 of FIG. 1). The system may further include a publication module (e.g., the publication module A-N of FIG. 1) of at least one site (e.g., the site 126A-N of FIGS. 1-2) to publish (e.g., on a html document) a set of results of a build (e.g., when the user 134A-N selects the publish selection 350 of FIG. 3) and to define a set of access privileges (e.g., access rights) of the set of results.

An apparatus includes a data processing system (e.g., the data processing system 132A-N of FIG. 1) that may manage development of a software product; database (e.g., the code database 122 of FIG. 1) coupled to the data processing system (e.g., the data processing system 132A-N of FIG. 1) to provide a code (e.g., the code 202A-N of FIG. 2) of the software product and/or to archive a build configuration (e.g., the build run parameters 402) of a build, a build module (e.g., the remote build module 130, integration build module 102, etc. of FIG. 1), of the data processing system (e.g., the data processing system 132A-N of FIG. 1) may parse and/or may translate (e.g., compile, execute, interpret, and/or run) the code (e.g., the code 202 of FIG. 2) to create an executable state of the code, to identify a breakage point of the code (e.g., the broken point 216 of FIG. 2), and/or to provide a previous clean state (e.g., last known clean state) of the code (e.g., previous clean integration build 214 of FIG. 2, last clean integration build, previous clean build).

In addition, the apparatus may include a schedule build module (e.g., schedule build module 104 of FIGS. 1-2) of the data processing system (e.g., the data processing system 132A-N of FIG. 1) that may parse and/or translate the code (e.g., the code 202 of FIG. 2) to create the executable state of the code according to a definable timetable and/or to process the previous clean state of the code to enable testing, development, and/or distribution of the software product. The apparatus may also include an integration build module (e.g., the integration build module 102 of FIGS. 1-2) of the data processing system (e.g., the data processing system 132A-N of FIG. 1) to integrate a code change of the code with the previous clean state (e.g., last known clean state) of the code (e.g., previous clean integration build 214 of FIG. 2, last clean integration build, previous clean build) and/or to provide the schedule build module (e.g., schedule build module 104 of FIGS. 1-2) with a clean state of the code (e.g., schedule build using previous clean build 222 of FIG. 2).

The apparatus may further include a remote build module (e.g., remote build module 130 of FIG. 1) coupled to the data processing system (e.g., the data processing system 132A-N of FIG. 1) to parse and/or to translate the code (e.g., the code 202A-N of FIG. 1) to create the executable state of the code from a remote site (e.g., the site 126A-N of FIGS. 1-2), and to provide the executable state of the code to the data processing system (e.g., the data processing system 132A-N of FIG. 1). Moreover, the apparatus may include a publication module (e.g., the publication module 128A-N of FIG. 1) coupled to the data processing system (e.g., the data processing system 132A-N of FIG. 1) to publish a set of results (e.g., when the user 134A-N request to publish set of results through the user interface) of the build of the code to enable access of the set of results by various users (e.g., user 134A-N of FIG. 1) and/or to define a set of access privileges of the set of results. In addition, the apparatus may include a historical build module (e.g., the historical build module 106 of FIG. 1) of the data processing system (e.g., the data processing system 132A-N of FIG. 1) to reproduce the build based on information of the build configuration.

Furthermore, the apparatus may include a version control system (e.g., version control system 118 of FIG. 1) coupled to the data processing system (e.g., the data processing system 132A-N of FIG. 1) to process a submission to the code, to keep track of code changes, to provide a change list of the code changes (e.g., through change list 120 of FIG. 1), and/or to provide a feedback of the code changes. The apparatus may include a regular expression generator module (e.g., the regular expression generator module 108 of FIG. 1) of the data processing system (e.g., the data processing system 132A-N of FIG. 1) to generate a regular expression of a definable string to search a log of the build. Also, the apparatus may include a discovery module (e.g., the discovery module 110 of FIG. 1) of the data processing system (e.g., the data processing system 132A-N of FIG. 1) to establish a presence at least one software configuration management component.

In addition, the apparatus may include an administration module (e.g., the administration module 116 of FIG. 1) of the data processing system (e.g., the data processing system 132A-N of FIG. 1) to define a build group having at least one build. The apparatus may also include an interface module (e.g., the interface module 114 of FIG. 1) of the data processing system (e.g., the data processing system 132A-N of FIG. 1) to display at least one of the log, the set of results, and a status of the build group (e.g., through the user interface). Moreover, the apparatus may include a load balancing module (e.g., the load balancing module 112 of FIG. 1) of the data processing system to optimize performance of any of the at least one software configuration management component and the build module (e.g., the integration build module 102, the schedule build module 104, etc. of FIG. 1).

FIG. 2 is a code line view 200 of a schedule build using previous clean build 222, according to one embodiment. Particularly, code 202A-N, a,state of code base 204, code change 206A-N, a clean state of code base 208, a schedule build 210, a integration build 212, a previous clean integration build 214, a broken point 216, a broken state of code base 218, a link to previous clean build 220, a schedule build using previous clean build 222, and a code fix point 224. In the example embodiment illustrated in FIG. 2, the code line view 200 may indicate a time line of development of the software product and/or a chronology of builds (e.g., a schedule build, a manual build, an integration build, etc.) of any of the files of the code base (e.g., the code database 122 of FIG. 1) accessed, operated and/or stored by the user 134A-N (e.g., programmers, project managers, testers, software and/or hardware engineers, inventors, human-computer interaction specialist, etc.). The code 202A-N may be modified by the user 134A-N (e.g., cause of the code change 206A-N of FIG. 2) from any of the site 126A-N. The state of code base 204 (e.g., clean, broken, etc.) represents the status of overall code state during its timeline. The code change 206A-N may be a particular modification of the code (e.g., the integration build 212 of FIG. 2) to be integrate modification into the code database (e.g., the code database 122 of FIG. 1) and/or may update previous clean state (e.g., last known clean state) of the code (e.g., previous clean integration build 214 of FIG. 2) upon a successful build.

The clean state of the code base 208 may indicate that the code base is in a buildable and/or executable state and/or may be translated from source code of the code base. The schedule build 210 may occur at a definable timetable to process the previous clean state of the code to enable testing, development and/or distribution of the software product. The integration build 212 incorporates the code change 206A-N into the software product. The previous clean integration build 214 may be a prior successful integration build of the code base. The broken point 216 may be a point in time when a modification may not be integrated (e.g., code may have errors preventing compilation, execution, and/or interpretation). The broken state of the code base 218 may be the state of the code after the broken point. The link to previous clean build 220 may alleviate problems associated with the broken state of code base 218 by providing the previous clean integration build 214 to the schedule build module 104. The schedule build using the previous clean build 222 may process and/or use the previous clean integration build 214 in order to provide an executable software product to the user 134A-N (e.g., for testing, quality assurance, etc.). The code fix point 224 may be a point in time where a particular code change of the code change 206A-N may correct the errors of the code base and return the code base to a clean and/or buildable state. Further, the modifications may be integrated only after the code 202A-N has been fixed (e.g., code fix point 224 of FIG. 2) which may return the clean state of code base 208. In case there exists the broken point 216 at the time of the integration build 212, then the modifications take place only after code fix point 224 is realized.

Furthermore, a code (e.g., the code 202A-N of FIG. 2) of a software product and/or a previous clean state of the code may be provided. The code (e.g., the code 202A-N of FIG. 2) may be modified by various users (e.g., the code change 206A of FIG. 2) of a number of sites. The code (e.g., the code 202A-N of FIG. 2) may be built to integrate modifications of the code with the previous clean state of the code (e.g., previous clean integration build 214 of FIG. 2) and/or the previous clean state of the code may be updated upon a successful build. A breakage point of the code (e.g., the broken point 216 of FIG. 1) may be identified such that the code (e.g., the code 202A-N of FIG. 2) cannot build successfully caused by any one of the modification.

Moreover, the previous clean state of the code may be built upon identification of the breakage point (e.g., broken point 216 of FIG. 2) to enable development of the software product and/or to mitigate problems associated with an unsuccessful build of the code.

FIG. 3 is a result view 300 of a user interface 302, according to one embodiment. The result view 300 of FIG. 3 illustrates a build result 304, a build name 306, a activate command 308, a start command 310, a edit command 312, a command command 314, a build number 316, a result 318, a start time 320, a finish time 322, a sequence results 324, a step name 326, a result 328, logs 330, a information on changes 332, a release notes 334, report 336, a diff 338, a history 340, a build list 342, a file test result 344, a directory test result 346, a directory test result that doesn't exist 348, and/or a publish selection 350, according to one embodiment. The user interface 302 may display the build result 304 that may contain the information such as the build name 306, the build number 316, the result 318 (e.g., successful, broken, etc.), the start time 320, the finish time 322 associated with the particular build. The user interface 302 may enable the user to activate, start, edit and command the build through links to the activate command 308, the start command 310, the edit command 312, the command command 314, respectively.

The user interface 302 may display the sequence results 324 that may include information such as the step name 326 (e.g., build, test, etc.), the result 328 (e.g., successful, broken, etc.), the logs 330 (e.g., STDOUT, STDIN, etc.). The user interface 302 may further offer information on the changes 332, the logs 330, the release notes 334, the report 336, the diff 338, the history 340, and/or the build list 342. In addition, the user interface 302 may enable the user (e.g., the user 134A-N of FIG. 1) to view and/or publish the file test result 344, the directory test result 346, the directory test result that doesn't exist 348 using the publish selection 350.

In addition, a set of results of a build of the code (e.g., the result 318) may be published to a page accessible by various users (e.g., the user 134A-N of FIG. 1) of any of the number of sites (e.g., the site 126A-N of FIG. 1). A set of access privileges may also be defined to the page of the various users (e.g., the user 134A-N of FIG. 1).

FIG. 4A is an interface view 400A of a build run parameters 402, according to one embodiment. Particularly, the interface view 400A illustrates the build run parameters 402, a delete command 404, a add command 406, a variable field 408, a description field 410, a type field 412, a values field 414, and required field 416, according to one embodiment. The build run parameters 402 may display the variable field 408 that may include information on shell variables such as IS_RELEASE_BUILD, RELEASE_VERSION, DEPLOY_TO_QA, etc. The delete command 404 may enable the user 134A-N to delete a particular parameter of the build run parameters 402. The add command 406 may enable the user 134A-N to add a new particular parameter to the build run parameters 402. The variable field 408 may display the name of a shell variable of the build run parameters 402 of the build. The description field 410 may display the instructions to the user (e.g., the user 134A-N of FIG. 1) to set the values (e.g., the values of the values field 412 of FIG. 4A) in response to the variable field 408.

The type field 412 of the build run parameters 402 may display the method of selection (e.g., radio list, single value, drop down list, etc.) of the values (e.g., the values of the values field 412 of FIG. 4A) in response to the variable field 408. The values 414 may display all the possible outcome and/or values (e.g., the values of the values field 412 of FIG. 4A) that can be entered and/or selected by the user (e.g., the user 134A-N of FIG. 1). The required field 416 may include a check box option that may facilitate the user (e.g., the user 134A-N of FIG. 1) to select the variables (e.g., the variable field 408 of FIG. 1) from the screen.

For example, a build configuration of the build may be defined and archived and/or the build may be reproduced based on a set of parameters of the build configuration (e.g., through the build run parameters 402 of FIG. 4A).

FIG. 4B is an interface view 400B of the build run parameters 402, according to one embodiment. Particularly the interface view 400B of FIG. 4B illustrates a starting build field 418, a note field 420, a shell variable field 422, a set to value field 424, and label field 426, according to one embodiment. The interface view 400B may provide the build run parameters 402 to the customer build script in the form of shell variables 422 that may be used to control behavior of the build without changing the actual build script.

The starting build field 418 may display a descriptive name of the build performed by the user (e.g., the user 134A-N of FIG. 1). The note field 420 may display a comment created by the user 134A-N of the build. The shell variable field 422 may display the different variables such as IS_RELEASE_BUILD, RELEASE_VERSION, DEPLOY_TO_QA, etc. The set to value field 424 may display the values manually selected by the user (e.g., the user 134A-N of FIG. 1) in response to the particular shell variable 422. The label 426 may display information regarding the build performed by the user (e.g., the user 134A-N of FIG. 1) on schedule build (e.g., the schedule build 210 of FIG. 2).

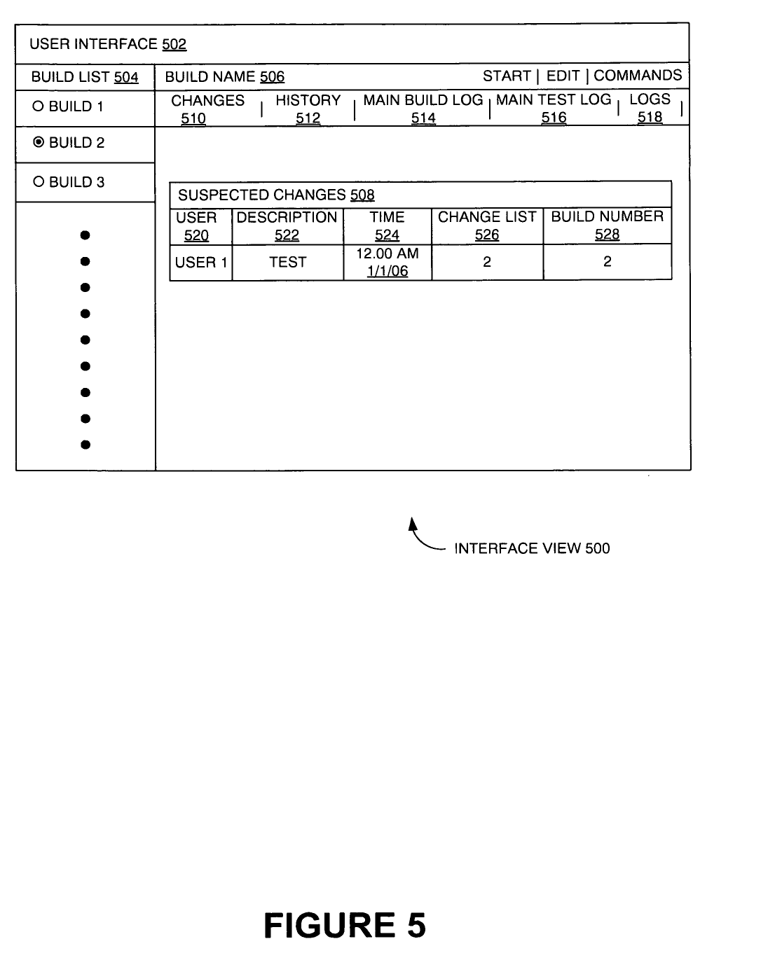

FIG. 5 is an interface view 500 of a user interface 502, according to one embodiment. Particularly the interface view 500 of FIG. 5 illustrates the user interface 502, a build list field 504, a build name field 506, a suspected changes field 508, a changes command 510, a history command 512, a main build log command 514, a main test log command 516, a logs command 518, a user 520, a description 522, a time 524, a change list command 526, and a build number 528, according to one embodiment. The interface view 500 may display the build list 504 (e.g., build 1, build 2, build 3, etc). The user interface 502 may facilitate the user (e.g., the user 134A-N of FIG. 1) to select any of the builds among the various builds displayed under the build list 504.

The build list 504 may be a list of current build configurations (e.g., the build run parameters 402 of FIGS. 4A-B) of current builds. The build name 506 may be a descriptive name of a certain build (e.g., build 1, build 2, etc.) of the build list 504. The suspected changes 508 may be a list of changes to the code (e.g., the code database 122 of FIG. 1). The changes command 510 may display the suspected changes 508. The history command 512 may display a history (e.g., a chronology) of the certain build of the build list 504. The main build log command 514 may display a main build log of the certain build. The main test log command 516 may display a main test log of the certain build. The logs command 518 may display logs of a run of the certain build. The user 520 (e.g., the user 134A-N of FIG. 1) may access information of the build using the changes command 510, the history command 512, the main build log command 514, the main test log command 516, the logs 518 command. In addition the user 520 (e.g., the user 134A-N of FIG. 1) can access information on the suspected changes 508 performed earlier. The description field 522 may provide a description of the certain build to inform the manager of particular characteristics of the certain build. The time field may display the time of the run of the certain build. The change list 526 may display a number of a change of the change list. The build number 528 may be a number of the certain build known by the software build management server (e.g., the software build management server 100 of FIG. 1).

Moreover, a build group of at least one build may be defined to organize the at least one build.

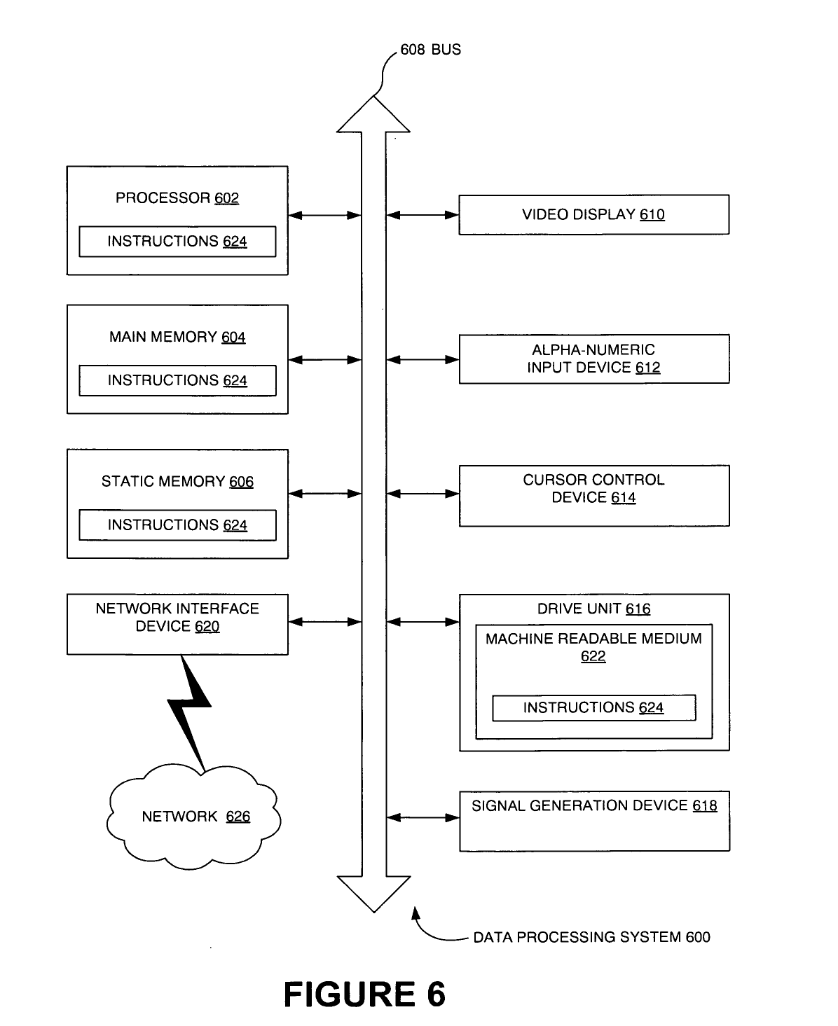

FIG. 6 is a diagrammatic system view of a data processing system 600 in which any of the embodiments disclosed herein may be performed, according to one embodiment. Particularly, the data processing system 600 of FIG. 6 illustrates a processor 602, a main memory 604, a static memory 606, a bus 608, a video display 610, an alpha-numeric input device 612, a cursor control device 614, a drive unit 616, a signal generation device 618, a machine readable medium 622, instructions 624, and a network 626, according to one embodiment.

The data processing system 600 may indicate a personal computer and/or a data processing system in which one or more operations disclosed herein are performed. The processor 602 may be microprocessor, a state machine, an application specific integrated circuit, a field programmable gate array, etc. (e.g., Intel® Pentium® processor). The main memory 604 may be a dynamic random access memory and/or a primary memory of a computer system. The static memory 606 may be a hard drive, a flash drive, and/or other memory information associated with the data processing system.

The bus 608 may be an interconnection between various circuits and/or structures of the data processing system. The video display 610 may provide graphical representation of information on the data processing system. The alpha-numeric input device 612 may be a keypad, keyboard and/or any other input device of text (e.g., a special device to aid the physically handicapped). The cursor control device 614 may be a pointing device such as a mouse.

The drive unit 616 may be a hard drive, a storage system, and/or other longer term storage subsystem. The signal generation device 618 may be a bios and/or a functional operating system of the data processing system. The machine readable medium 622 may provide instructions on which any of the methods disclosed herein may be performed. The instructions 624 may provide source code and/or data code to the processor 602 to enable any one/or more operations disclosed herein.

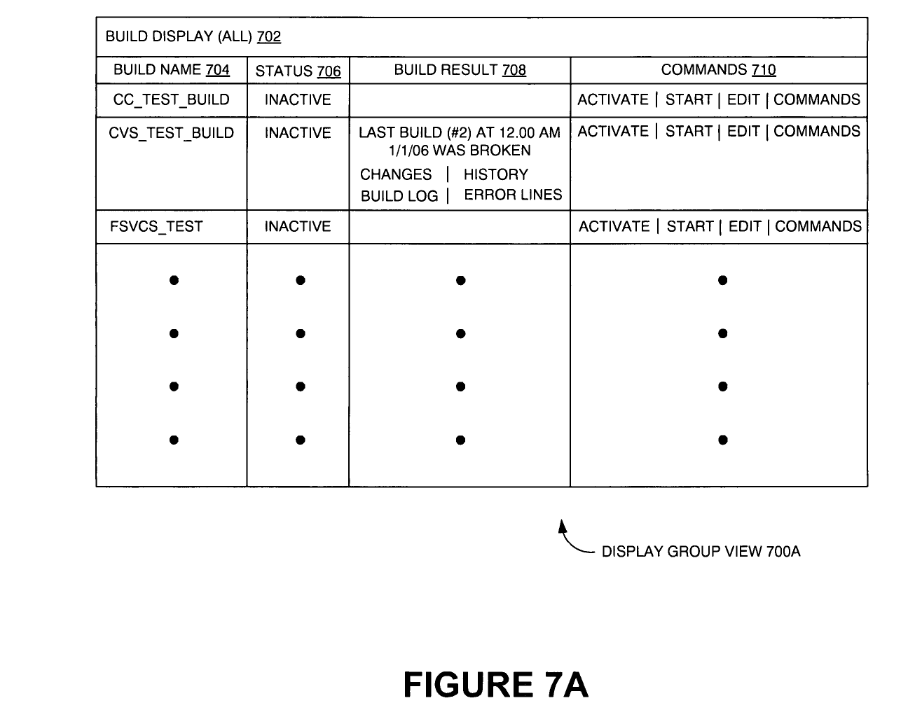

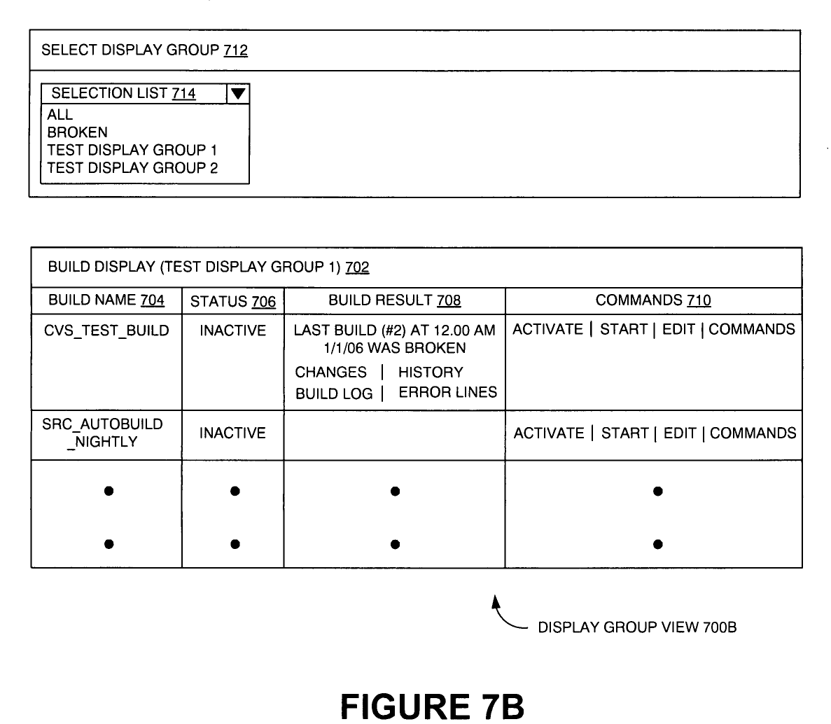

FIG. 7A is a display group view 700A of a build display 702, according to one embodiment. Particularly the display group view 700A of FIG. 7A illustrates a build name field 704, a status field 706, a build result field 708, and a commands field 710, according to one embodiment. In the example embodiment illustrated in FIG. 7A, the display group view 700A may display the build display (all) 702 that may show details of all the builds performed by the user (e.g., the user 134A-N of FIG. 1). The build display (all) 702 may display the build name field 704, the status field 706, the build result field 708, and/or the commands field 710.

The build name field 704 may contain information about the name of the build assigned by the user (e.g., the user 134A-N of FIG. 1). The status field 706 may contain information on the status on the activity of the build (e.g., active, inactive, etc.). The build result field 708 may contain information on the history of last performed build (e.g., last build (#2) at 12:00 am on Jan. 1, 2006, etc), the performance of the build (e.g., broken, successful, etc.) and/or may also allow the user (e.g., the user 134A-N of FIG. 1) to access more information (e.g., changes, history, build log, error lines, etc.) about the last build performed by the user (e.g., the user 134A-N of FIG. 1). The commands field 710 that may provide commands such as “activate”, “start”, “edit”, “commands” corresponding to the various builds.

FIG. 7B is a display group view 700B of a select display group 712, according to one embodiment. Particularly the display group view 700B of FIG. 7B illustrates the build display (test display group 1) 702, the build name field 704, the status field 706, the build result field 708, the commands field 710, the select display group 712, and a selection list field 714, according to one embodiment. In the example embodiment illustrated in FIG. 7B, the display group view 700B may display the build display (test display group 1) 702 that may show details about the builds performed by the user. The build display (test display group 1) 702 may display details of the test display build group 1.

The build name field 704 may contain information about the name of the build assigned by the user. The status field 706 may contain information on the status on the activity of the build (e.g., active, inactive, etc.). The build result field 708 may contain information on the history of last performed build (e.g., last build (#2) at 12:00 am on Jan. 1, 2006, etc), the performance of the build (e.g., broken, successful, etc.) and/or may also allow the user (e.g., the user 134A-N of FIG. 1) to access more information (e.g., changes, history, build log, error lines, etc.) about the last build performed by the user (e.g., the user 134A-N of FIG. 1). The commands field 710 that may contain commands such as “activate”, “start”, “edit”, “commands” corresponding to the various builds of the test display group 1. The select display group field 712 may enable the user to select a build group to display. The selection list field 714 may be a drop down box and may facilitate the user to access information related to the different build display groups (e.g., all, broken, test display group 1, test display group 2, etc.).

FIG. 8 is a table view of a build configuration table 800, according to one embodiment. Particularly the build configuration table 800 of FIG. 8 illustrates a build name field 802, a time started field 804, a time ended field 806, a VCS location filed 808, a vcs location field 808, a schedule field 810, a logs field 812, a build result location 814, a publication status field 816, a build script field 818, a build commands field 820, according to one embodiment.

The build configuration table 800 may define a set of items that may include a build name, a location information (e.g., a port, an IP address, a path) of a file of the version control system, a schedule to poll version control system for changes to the code base, logs, a build result location and/or publication, access privileges, etc. The build name field 802 may indicate the name of the build performed by the user (e.g., the user 134A-N of FIG. 1). The time started field 804 may indicate the start time of the build run. The time ended field 806 may indicate the end time of the build run.

The VCS location field 808 may indicate the location of the file in the version control system (e.g., the version control system 118 of FIG. 1). The schedule field 810 may indicate the nature and/or frequency of the schedule of various test builds conducted by the various users (e.g., the user 134A-N of FIG. 1). The logs field 812 may display the log links of the various software builds. The build result location field 814 may indicate the location of results of the build run parameters.

The publication status field 816 may indicate the status of publication of the set of results (e.g., published, unpublished, etc.). The build script field 818 may indicate location of the script associated with the build of the software application. The build commands field 820 may indicates the commands that may facilitate the user (e.g., the user 134A-N of FIG. 1) to manipulate the existing build.

The build name field 802 displays “test_build 1” in the first row and “test_build 2” in the second row of the build name field 802 column of the build configuration table 800 illustrated in FIG. 8. The time started field 804 displays “12:00 am” in the first row and “12:00 pm” second row of the time started field 804 column of the build configuration table 800 illustrated in FIG. 8. The time ended field 806 displays “12:10 am” in the first row and “12:10 pm” second row of the time ended field 806 column of the build configuration table 800 illustrated in FIG. 8.

The VCS location field 808 displays “128.192” and “1.2:8000” in the first row and “128.192.” and “1.2:7000” in the second row of the VCS location field 808 column of the build configuration table 800 illustrated in FIG. 8. The schedule field 810 displays “integration” in the first row and “daily” in the second row of schedule field 810 column of the build configuration table 800 illustrated in FIG. 8. The logs field 812 displays “log link 1” in the first row and “log link 2” in the second row of the logs field 812 column of the build configuration table 800 illustrated in FIG. 8.

The build result location field 814 displays “result link 1” in the first row and “result link 2” in the second row of the build result location field 814 column of the build configuration table 800 illustrated in FIG. 8. The publication status field 816 displays

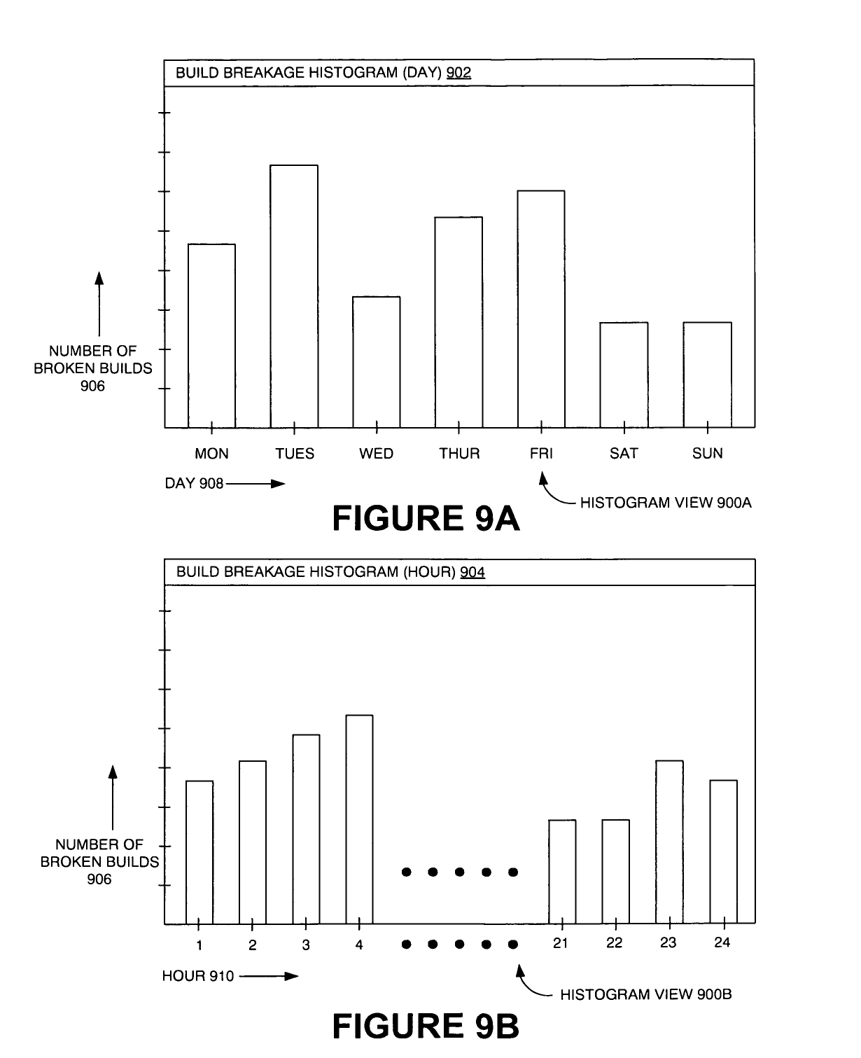

FIG. 9B is a histogram view 900B of a build breakage histogram (hour) 904, according to one embodiment. Particularly, the histogram view 900B of FIG. 9B illustrates the build breakage histogram (hour) 904, the number of broken builds 906, hours of the day 910, according to one embodiment. The histogram view 900B may offer an insight of the efficiency of performance of the build mechanism and/or may offer insights on the suggested hour of the day on which a more efficient performance may be anticipated statistically. The build breakage histogram (hour) 904 may indicate the relative historical representation of the build development process and may also represent the frequency of the broken builds.

In the example embodiment illustrated in FIG. 9B, the histogram view 900B illustrates a graphical representation of build breakages on different hours of the day. The hour 910 represents different hours of a day (e.g., 1 am, 2 pm, etc.). The number of broken builds 906 represents the number of build breakages on each day of the week.

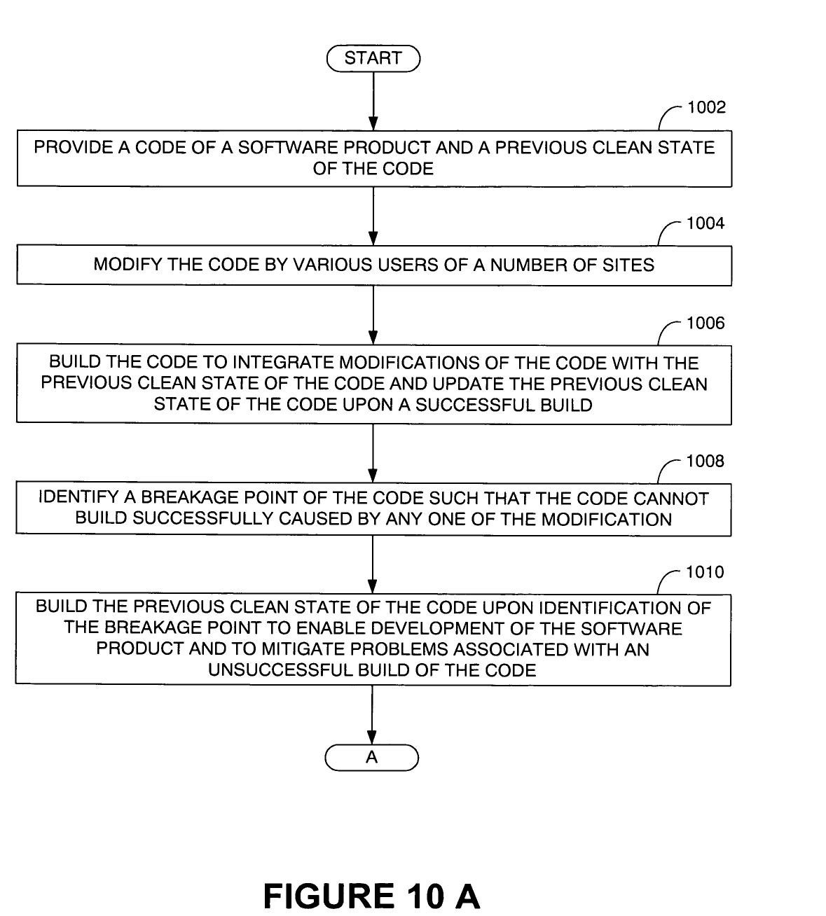

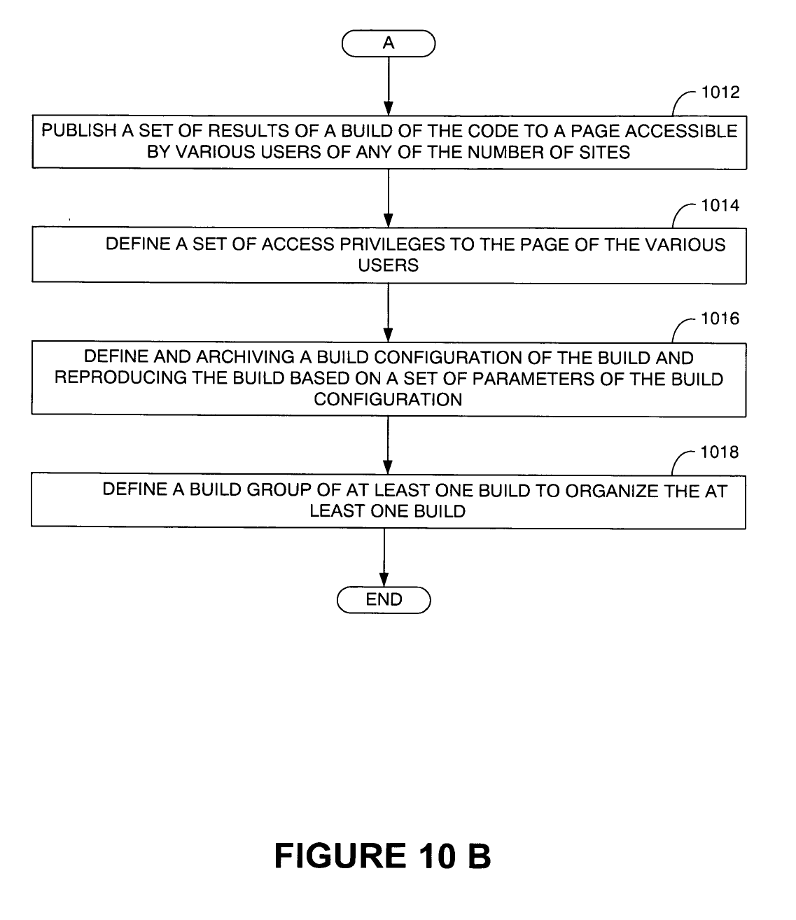

FIG. 10A is a process flow of providing a code of a software product, according to one embodiment. In operation 1002, a code (e.g., a code 202A-N of FIG. 2) of a software product and a previous clean state (e.g., a previous clean integration build 214 of FIG. 2) of the code (e.g., the code 202A-N of FIG. 2) may be provided. In operation 1004, the code (e.g., the code 202A-N of FIG. 2) may be modified by various users (e.g., a user 134A-N of FIG. 1) of a number of sites (e.g., a site 126A-N of FIG. 1).

In operation 1006, the code (e.g., the code 202A-N of FIG. 2) may be built to integrate modifications of the code (e.g., the code 202A-N of FIG. 2) with the previous clean state (e.g., the previous clean integration build 214 of FIG. 2) of the code (e.g., “published” in the first row and “unpublished” in the second row of the publication status 816 column of the build configuration table 800 illustrated in FIG. 8.

The build script field 818 displays “script link 1” in the first row and “script link 2” in the second row of the build script field 818 column of the build configuration table 800 illustrated in FIG. 8. The build commands 820 displays “active”, “edit”, “start”, and “commands” in the first row and “active”, “edit”, “start”, and “commands” in the second row of the build commands 820 column of the build configuration table 800 illustrated in FIG. 8.

FIG. 9A is a histogram view 900A of a build breakage histogram (day) 902, according to one embodiment. Particularly the histogram view 900A of FIG. 9A illustrates the build breakage histogram (day) 902, a number of broken builds 906, and a days of the week 908, according to one embodiment. The histogram view 900A may offer an insight of the efficiency of performance of the build mechanism and/or may offer insights on the suggested day of the week on which a more efficient performance may be anticipated statistically. The build breakage histogram (day) 902 may indicate the relative historical representation of the build development process and may also represent the frequency of the broken builds.

In the example embodiment illustrated in FIG. 9A, the histogram view 900A illustrates a graphical representation of build breakages on different days of the week. The number of broken builds 906 represents the number of build breakages on each day of the week. The day 908 represents different days of the week (e.g., Monday, Tuesday, Saturday, etc.). the code 202A-N of FIG. 2) and the previous clean state (e.g., the previous clean integration build 214 of FIG. 2) of the code (e.g., the code 202A-N of FIG. 2) may be updated upon a successful build.

In operation 1008, a breakage point (e.g., a broken point 216 of FIG. 2) of the code (e.g., the code 202A-N of FIG. 2) may be identified such that the code (e.g., the code 202A-N of FIG. 2) cannot build successfully caused by any one of the modification. In operation 1010, the previous clean state (e.g., the previous clean integration build 214 of FIG. 2) of the code (e.g., the code 202A-N of FIG. 2) may be built upon identification of the breakage point (e.g., the broken point 216 of FIG. 2) to enable development of the software product and to mitigate problems associated with an unsuccessful build of the code (e.g., the code 202A-N of FIG. 2).

FIG. 10B is a continuation of process flow of FIG. 10A showing additional processes, according to one embodiment. In operation 1012, a set of results of a build of the code (e.g., the code 202A-N of FIG. 2) may be published to a page accessible by various users (e.g., the user 134A-N of FIG. 1) of any of the number of sites (e.g., the site 126A-N of FIG. 1). In operation 1014, a set of access privileges may be defined to the page of the various users (e.g., the user 134A-N of FIG. 1). In operation 1016, a build configuration (e.g., a build configuration table 800 of FIG. 8) of the build may be defined and archived, and the build may be reproduced based on a set of parameters of the build configuration (e.g., the build configuration table 800 of FIG. 8). In operation 1018, the build group of at least one build may be defined to organize the at least one build.

Although the present embodiments have been described with reference to specific example embodiments, it will be evident that various modifications and changes may be made to these embodiments without departing from the broader spirit and scope of the various embodiments. For example, the various devices, modules, analyzers, generators, etc., described herein may be enabled and operated using hardware circuitry (e.g., CMOS based logic circuitry), firmware, software and/or any combination of hardware, firmware, and/or software (e.g., embodied in a machine readable medium).

For example, the various electrical structure and methods may be embodied using transistors, logic gates, and electrical circuits (e.g., application specific integrated ASIC circuitry and/or in Digital Signal; Processor DSP circuitry). For example, the integration build module 102, the schedule build module 104, the historical build module 106, the regular expression generator module 108, the discovery module 110, the load balancing module 112, the interface module 114, administration module 116, the publication module 128A-N, the remote build module 130, and other modules of FIGS. 1-10 may be embodied through a integration build circuit, a schedule build circuit, a historical build circuit, a regular expression generator circuit, a discovery circuit, a load balancing circuit, a interface circuit, administration circuit, a publication circuit, a remote build circuit, and other circuits using one or more of the technologies described herein.

In addition, it will be appreciated that the various operations, processes, and methods disclosed herein may be embodied in a machine-readable medium and/or a machine accessible medium compatible with a data processing system (e.g., a computer system), and may be performed in any order. Accordingly, the specification and drawings are to be regarded in an illustrative rather than a restrictive sense.

1. A system comprising:
a code of a software product;
at least one site to develop, to test, and to perform quality assurance of the code of the software product; and
a software build management server, having a number of build modules to build the code, to identify a breakage point of the code, and to process and to provide a previous clean state of the code.

2. The system of claim 1, further comprising a version control system to provide a change list to track a number of changes to the code and to provide a feedback of the number of changes.

3. The system of claim 2, further comprising at least one remote build module of the at least one site to build the code of the software product and to synchronize with the software build management server and the version control system.

4. The system of claim 3, further comprising a publication module of the at least one site to publish a set of results of a build and to define a set of access privileges of the set of results.

5. The system of claim 4, wherein the software build management server to define a build configuration as a set of parameters of the build of the code and to archive the build configuration to enable reproduction of the build.

6. A method comprising:
providing a code of a software product and a previous clean state of the code;
modifying the code by various users of a number of sites;
building the code to integrate modifications of the code with the previous clean state of the code and updating the previous clean state of the code upon a successful build; and
identifying a breakage point of the code such that the code cannot build successfully caused by any one of the modification.

7. The method of claim 6, further comprising building the previous clean state of the code upon identification of the breakage point to enable development of the software product and to mitigate problems associated with an unsuccessful build of the code.

8. The method of claim 7, further comprising publishing a set of results of a build of the code to a page accessible by various users of any of the number of sites.

9. The method of claim 8, further comprising defining a set of access privileges to the page of the various users.

10. The method of claim 9, further comprising defining and archiving a build configuration of the build and reproducing the build based on a set of parameters of the build configuration.

11. The method of claim 10, further comprising defining a build group of at least one build to organize the at least one build.

12. The method of claim 6 in a form of a machine-readable medium embodying a set of instructions that, when executed by a machine, causes the machine to perform the method of claim 6.

13. An apparatus comprising:
a data processing system to manage development of a software product;
a database coupled to the data processing system to provide a code of the software product and to archive a build configuration of a build; and
a build module of the data processing system to parse and to translate the code to create an executable state of the code, to identify a breakage point of the code, and to provide a previous clean state of the code.

14. The apparatus of claim 13, further comprising a schedule build module of the data processing system to parse and to translate the code to create the executable state of the code according to a definable timetable and to process the previous clean state of the code to enable testing, development, and distribution of the software product.

15. The apparatus of claim 14, further comprising an integration build module of the data processing system to integrate a code change of the code with the previous clean state of the code and to provide the schedule build module with a clean state of the code.

16. The apparatus of claim 15, further comprising a remote build module coupled to the data processing system to parse and to translate the code to create the executable state of the code and to provide the executable state of the code to the data processing system.

17. The apparatus of claim 16, further comprising a publication module coupled to the data processing system to publish a set of results of the build of the code to enable access of the set of results by various users, and to define a set of access privileges of the set of results.

18. The apparatus of claim 17, further comprising a historical build module of the data processing system to reproduce the build based on information of the build configuration.

19. The apparatus of claim 18, further comprising a version control system coupled to the data processing system to process a submission to the code, to keep track of code changes, to provide a change list of the code changes, and to provide a feedback of the code changes.

20. The apparatus of claim 19, further comprising a regular expression generator module of the data processing system to generate a regular expression of a definable string to search a log of the build.

21. The apparatus of claim 20, further comprising a discovery module of the data processing system to establish a presence of at least one software configuration management component.

22. The apparatus of claim 21, further comprising an administration module of the data processing system to define a build group having at least one build.

23. The apparatus of claim 22, further comprising an interface module of the data processing system to display at least one of the log, the set of results, and a status of the build group.

24. The apparatus of claim 23, further comprising a load balancing module of the data processing system to optimize performance of any of the at least one software configuration management component and the build module.
